(19) United States
(12) Patent Application Publication
(10) Pub. No.: US 2026/0365085 A1
(43) Pub. Date: Nov. 19, 2026

(54) SHUTTER DOOR DEVICE FOR RAIL

(71) Applicants: Hyundai Motor Company, Seoul (KR); Kia Corporation, Seoul (KR); Hyundai Mobis Co., Ltd., Seoul (KR)

(72) Inventors: Se Yoon Choi, Hwaseong (KR); Ji Yun Ha, Hwaseong (KR); Jung Hoon Woo, Hwaseong (KR); Chang Gil Park, Hwaseong (KR); Young Jin You, Yongin (KR); Jae Whoan Park, Yongin (KR)

(21) Appl. No.: 19/393,231

(22) Filed: Nov. 18, 2025

(30) Foreign Application Priority Data
May 16, 2025 (KR) 10-2025-0063645

(51) Int. Cl. B60N 2/07

(52) U.S. Cl. CPC B60N 2/0725

(57) ABSTRACT

The present disclosure provides a shutter door device for a rail including: a guide rail configured to guide linear movement of a slider; a movement guide passage provided in the guide rail and configured to provide a movement path for the slider; a plurality of first rotating blocks rotatably assembled to a first body portion of the guide rail and arranged in a row in the movement guide passage; and a plurality of second rotating blocks rotatably assembled to a second body portion of the guide rail and arranged in a row in the movement guide passage. The first body portion is provided opposite the second body portion with respect to the movement guide passage. Based on the slider moving along the movement guide passage, the slider causes the first rotating block and the second rotating block to rotate in a direction to open the movement guide passage.

### CROSS-REFERENCE TO RELATED APPLICATION

This application claims, under 35 U.S.C. §119(a), the benefit of Korean Patent Application No. 10-2025-0063645, filed May 16, 2025, in the Korean Intellectual Property Office, the entire contents of which are incorporated herein by reference.

### BACKGROUND

### (a) Technical Field

The present disclosure relates to a shutter door device for a rail and, more particularly, to a shutter door device for a rail which may prevent foreign substances from entering a guide rail and an interior of the guide rail from being exposed.

### (b) Description of the Related Art

In general, various position-variable utilities such as a seat, a moving console, or a sliding table are applied to a vehicle. A guide rail is used for linear movement of the position-variable utilities (i.e., a slider).

FIG. 10 is a view illustrating a guide rail installed on a floor panel of a conventional vehicle and a seat moving linearly along the guide rail. FIG. 11 is a view illustrating a guide rail installed on a crash pad of a conventional vehicle and a table moving linearly along the guide rail. FIG. 12 is a cross-sectional view taken along line A–A in FIG. 11.

As shown in FIGS. 10 and 11, conventional guide rails 10 and 20 are provided with movement guide passages 14 and 22 for guiding sliding movement of a seat rail (not illustrated) installed on a lower portion of a seat 12 and a table 24. The movement guide passages 14 and 22 extend linearly longer than a width of the slider to provide a movement path for the slider, such as the seat rails and the table 24, and, accordingly, a partially open region (i.e., an open region) is formed depending on the movement position of the slider.

The open region of the movement guide passages 14 and 22 varies depending on the movement position of the slider, and foreign substances may enter an inner space of the guide rails 10 and 20 through the open region. Referring to FIG. 12, a support structure 30 is installed in the inner space of the guide rail 20 to support the linear movement of the slider, and, accordingly, foreign substances may cause contamination and damage to the support structure.

In addition, there is potential for injury due to, for example, a user's finger being caught in the open region, and exposure of the support structure may compromise the aesthetics.

### SUMMARY

Disclosed embodiments provide a shutter door device for a rail configured to close a movement guide passage of a guide rail regardless of a movement position of a slider.

Various aspects of disclosed embodiments are not limited to the aspects mentioned above, and other aspects of the present disclosure not mentioned above will be clearly understood by those skilled in the art to which the present disclosure pertains from the following description.

The present disclosure provides a shutter door device for a rail, the shutter door device including: a guide rail configured to guide linear movement of a slider; a movement guide passage provided in the guide rail and configured to provide a movement path for the slider; a plurality of first rotating blocks rotatably assembled to a first body portion of the guide rail and arranged in a row in the movement guide passage; and a plurality of second rotating blocks rotatably assembled to a second body portion of the guide rail and arranged in a row in the movement guide passage. In this case, the first body portion is positioned opposite the second body portion with respect to the movement guide passage. In addition, based on the slider moving along the movement guide passage, the slider causes the first rotating block and the second rotating block to rotate in a direction to open the movement guide passage.

According to embodiments of the present disclosure, each of the first rotating blocks is rotatably coupled to the first body portion through a first rotation shaft and is provided with a first guide pin assembled into a first guide hole of the first body portion. Based on each of the first rotating blocks rotating about the first rotation shaft, the first guide pin moves along the first guide hole. In addition, the first guide hole extends to guide a rotational movement path of each of the first rotating blocks.

In addition, according to embodiments of the present disclosure, a first torsion spring is installed between the first body portion and each of the first rotating blocks. The first torsion spring includes a first end coupled to the first body portion and a second end coupled to each of the first rotating blocks. The first torsion spring is compressed, based on each of the first rotating blocks rotating in a direction to open the movement guide passage.

In addition, according to embodiments of the present disclosure, each of the second rotating blocks is rotatably coupled to the second body portion through a second rotation shaft and is provided with a second guide pin assembled into a second guide hole of the second body portion. The second guide pin moves along the second guide hole, based on each of the second rotating blocks rotating about the second rotation shaft. In addition, the second guide hole extends to guide a rotational movement path of each of the second rotating blocks.

In addition, according to embodiments of the present disclosure, a second torsion spring is installed between the second body portion and each of the second rotating blocks. The second torsion spring includes a first end coupled to the second body portion and a second end coupled to each of the second rotating blocks. The second torsion spring is compressed, based on each of the second rotating blocks rotating in a direction to open the movement guide passage.

In addition, the shutter door device of the present disclosure further includes: a first linear guide provided at a center of the first body portion; and a first linear block assembled to the first linear guide and disposed in the movement guide passage. The first linear guide is provided with a first linear hole for guiding movement of the first linear block, and the first linear hole extends in a direction perpendicular to a movement direction of the slider.

According to embodiments of the present disclosure, first inclination surfaces having a predetermined curvature are provided on both sides of the first linear block, respectively. Based on the slider moving along the movement guide passage, the first inclination surfaces are pushed by coming into contact with the slider.

In addition, according to embodiments of the present disclosure, a first return spring is mounted between the first linear block and the first linear guide. Based on the first linear block moving by being pushed by the slider, the first return spring is compressed.

In addition, according to embodiments of the present disclosure, the plurality of first rotating blocks assembled to the first body portion are symmetrical with each other with respect to the first linear block.

In addition, the shutter door device of the present disclosure further includes: a second linear guide provided at a center of the second body portion; and a second linear block assembled to the second linear guide and disposed in the movement guide passage. The second linear guide is provided with a second linear hole for guiding movement of the second linear block, and the second linear hole extends in a direction perpendicular to a movement direction of the slider.

In addition, according to embodiments of the present disclosure, second inclination surfaces having a predetermined curvature are provided on both sides of the second linear block, respectively. Based on the slider moving along the movement guide passage, the second inclination surfaces are pushed by coming into contact with the slider.

In addition, according to embodiments of the present disclosure, a second return spring is mounted between the second linear block and the second linear guide. Based on the second linear block moving by being pushed by the slider, the second return spring is compressed.

In addition, according to embodiments of the present disclosure, the plurality of second rotating blocks assembled to the second body portion are symmetrical with each other with respect to the second linear block.

The present disclosure automatically closes an open region of the movement guide passage that varies depending on the movement position of the slider. Accordingly, the present disclosure may prevent foreign substances from entering an interior of the guide rail through the movement guide passage and a human body part from being caught, and may also prevent exposure of an internal structure of the guide rail.

The effects of the present disclosure are not limited to the effects mentioned above, and other effects of the present disclosure not mentioned above will be clearly understood by those skilled in the art to which the present disclosure pertains from the following description.

According to an aspect of the present disclosure, a shutter door device for a rail is provided. The shutter door device may comprise a guide rail configured to guide linear movement of a slider, a movement guide passage provided in the guide rail configured to provide a movement path for the slider, and a plurality of rotating blocks rotatably assembled to a body portion of the guide rail and arranged in a row in the movement guide passage. The plurality of rotating blocks may be configured to rotate in a direction to open the movement guide passage when the slider moves along the movement guide passage.

According to an exemplary embodiment, each of the plurality of rotating blocks may be rotatably coupled to the body portion through a rotation shaft and is provided with a guide pin assembled into a guide hole of the body portion, and, based on each of the plurality of rotating blocks rotating about the rotation shaft, the guide pin may be configured to move along the guide hole.

According to an exemplary embodiment, the guide hole may extend to guide a rotational movement path of each of the plurality of rotating blocks.

According to an exemplary embodiment, the shutter door device may comprise a torsion spring installed between the body portion and each of the plurality of rotating blocks. The torsion spring may comprise a first end coupled to the body portion and a second end coupled to each of the plurality of rotating blocks, and, based on each of the plurality of rotating blocks rotating in a direction to open the movement guide passage, the torsion spring may be configured to be compressed.

According to an exemplary embodiment, the shutter door device may comprise a linear guide provided at a center of the body portion and a linear block assembled to the linear guide and disposed in the movement guide passage. The linear guide may be provided with a linear hole for guiding movement of the linear block, and the linear hole may extend in a direction perpendicular to a movement direction of the slider.

According to an aspect of the present disclosure, a shutter door device for a rail is provided. The shutter door device may comprise a guide rail configured to guide linear movement of a slider, a movement guide passage provided in the guide rail and configured to provide a movement path for the slider, a plurality of first rotating blocks rotatably assembled to a first body portion of the guide rail and arranged in a row in the movement guide passage, and a plurality of second rotating blocks rotatably assembled to a second body portion of the guide rail and arranged in a row in the movement guide passage. The first body portion may be positioned opposite the second body portion with respect to the movement guide passage, and the first rotating blocks and the second rotating blocks may be configured to rotate in a direction to open the movement guide passage when the slider moves along the movement guide passage.

According to an exemplary embodiment, each of the first rotating blocks may be rotatably coupled to the first body portion through a first rotation shaft and is provided with a first guide pin assembled into a first guide hole of the first body portion, and, based on each of the first rotating blocks rotating about the first rotation shaft, the first guide pin may be configured to move along the first guide hole.

According to an exemplary embodiment, the first guide hole may extend to guide a rotational movement path of each of the first rotating blocks.

According to an exemplary embodiment, the shutter door device may comprise a first torsion spring installed between the first body portion and each of the first rotating blocks. The first torsion spring may comprise a first end coupled to the first body portion and a second end coupled to each of the first rotating blocks, and, based on each of the first rotating blocks rotating in a direction to open the movement guide passage, the first torsion spring may be configured to be compressed.

According to an exemplary embodiment, each of the second rotating blocks may be rotatably coupled to the second body portion through a second rotation shaft and is provided with a second guide pin assembled into a second guide hole of the second body portion, and the second guide pin may be configured to move along the second guide hole, based on each of the second rotating blocks rotating about the second rotation shaft.

According to an exemplary embodiment, the second guide hole may extend to guide a rotational movement path of each of the second rotating blocks.

According to an exemplary embodiment, the shutter door device may comprise a second torsion spring installed between the second body portion and each of the second rotating blocks. The second torsion spring may comprise a first end coupled to the second body portion and a second end coupled to each of the second rotating blocks, and, based on each of the second rotating blocks rotating in a direction to open the movement guide passage, the second torsion spring may be configured to be compressed.

According to an exemplary embodiment, the shutter door device may comprise a first linear guide provided at a center of the first body portion and a first linear block assembled to the first linear guide and disposed in the movement guide passage. The first linear guide may be provided with a first linear hole for guiding movement of the first linear block, and the first linear hole may extend in a direction perpendicular to a movement direction of the slider.

According to an exemplary embodiment, the shutter door device may comprise first inclination surfaces having a predetermined curvature provided on both sides of the first linear block, respectively. Based on the slider moving along the movement guide passage, the first inclination surfaces may be configured to be pushed by coming into contact with the slider.

According to an exemplary embodiment, the shutter door device may comprise a first return spring mounted between the first linear block and the first linear guide. Based on the first linear block moving by being pushed by the slider, the first return spring may be configured to be compressed.

According to an exemplary embodiment, the plurality of first rotating blocks assembled to the first body portion may be symmetrical with each other with respect to the first linear block.

According to an exemplary embodiment, the shutter door device may comprise a second linear guide provided at a center of the second body portion, and a second linear block assembled to the second linear guide and disposed in the movement guide passage. The second linear guide may be provided with a second linear hole for guiding movement of the second linear block, and the second linear hole may extend in a direction perpendicular to a movement direction of the slider.

According to an exemplary embodiment, the shutter door device may comprise second inclination surfaces having a predetermined curvature provided on both sides of the second linear block, respectively. Based on the slider moving along the movement guide passage, the second inclination surfaces may be configured to be pushed by coming into contact with the slider.

According to an exemplary embodiment, the shutter door device may comprise a second return spring mounted between the second linear block and the second linear guide. Based on the second linear block moving by being pushed by the slider, the second return spring may be configured to be compressed.

According to an exemplary embodiment, the plurality of second rotating blocks assembled to the second body portion may be symmetrical with each other with respect to the second linear block.

### BRIEF DESCRIPTION OF THE DRAWINGS

The foregoing and other aspects, features, and advantages, as well as the following detailed description of the embodiments, will be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 is a view illustrating a shutter door device for a rail, according to an exemplary embodiment of the present disclosure.

FIGS. 2A and 2B are views illustrating a rotating block of the shutter door device, according to exemplary embodiments of the present disclosure.

FIG. 3 is a partial view illustrating a guide rail of the shutter door device, according to an exemplary embodiment of the present disclosure.

FIG. 4 is a view illustrating a linear block of the shutter door device for a rail, according to an exemplary embodiment of the present disclosure.

FIG. 5 is a view illustrating a linear guide provided in the guide rail of the shutter door device for a rail, according to an exemplary embodiment of the present disclosure.

FIG. 6 is a view illustrating a state in which a slider has moved to a left area of a movement guide passage, according to an exemplary embodiment of the present disclosure.

FIG. 7 is a view indicating, with arrows, a movement direction of the linear block and a rotation direction of the rotating block during movement of the slider, according to an exemplary embodiment of the present disclosure.

FIG. 8 is a view illustrating a rail of a crash pad for a vehicle to which the shutter door device of the present disclosure is applied.

FIG. 9 is a view illustrating a rail of a floor panel for a vehicle to which the shutter door device of the present disclosure is applied.

FIG. 10 is a view illustrating a guide rail installed on a floor panel of a conventional vehicle and a seat moving linearly along the guide rail.

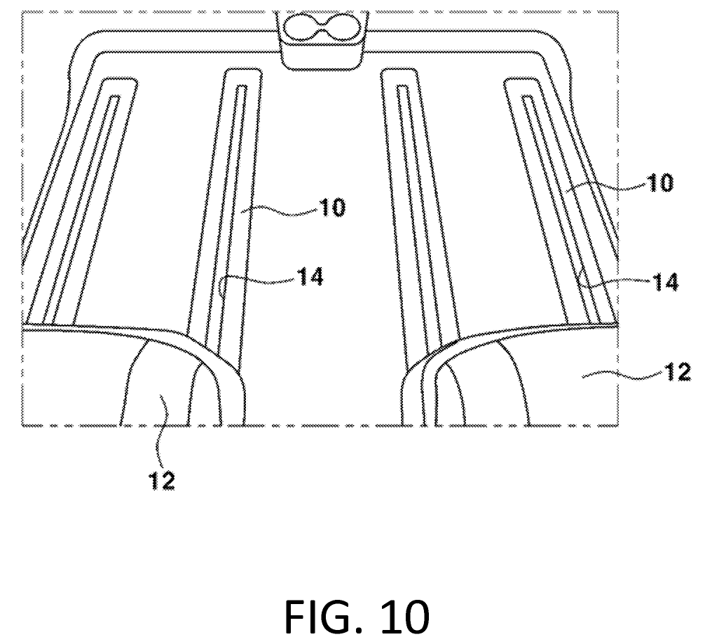

FIG. 11 is a view illustrating a guide rail installed on a crash pad of a conventional vehicle and a table moving linearly along the guide rail.

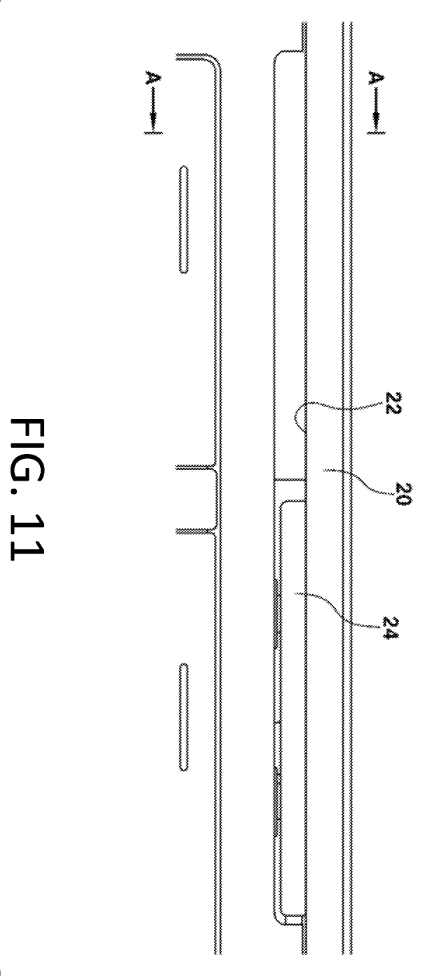

FIG. 12 is a cross-sectional view taken along line A–A in FIG. 11.

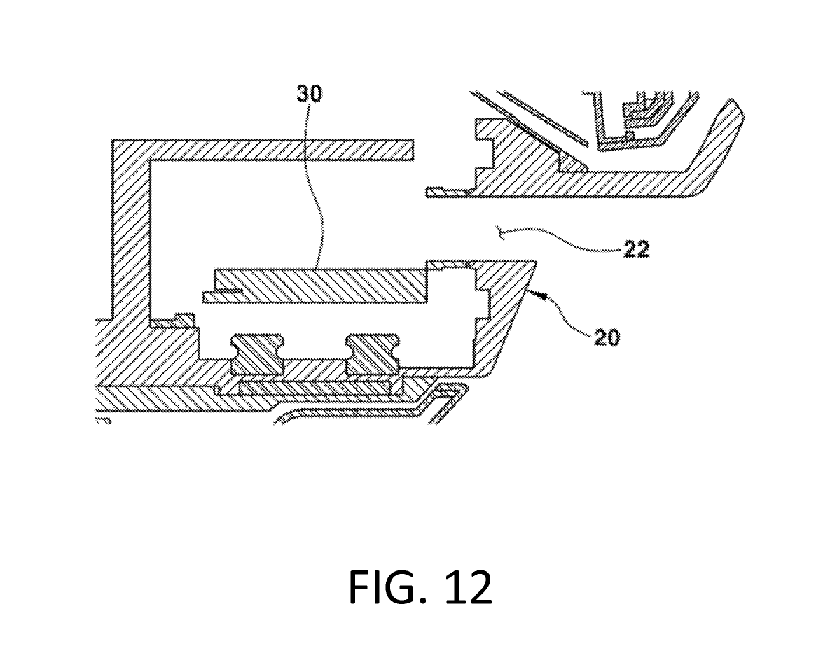

### DETAILED DESCRIPTION

Embodiments of the present disclosure will be described below with reference to the accompanying drawings. The matters included in the accompanying drawings are illustrated to facilitate the description of embodiments of the present disclosure, and may differ from the forms actually implemented.

In addition, terms such as first, second, and the like used herein may be used to describe various components, but the various components are not limited by these terms. The terms are used solely for the purpose of distinguishing one component from other components. For example, a first component may be referred to as a second component, and a second component may also be referred to as a first component, without departing from the scope of rights according to the inventive concepts of the present disclosure.

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well-known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

The terminology used herein is for the purpose of describing particular embodiments only and is not intended to be limiting of the disclosure. As used herein, the singular forms "a," "an" and "the" are intended to include the plural forms as well, unless the context clearly indicates otherwise. These terms are merely intended to distinguish one component from another component, and the terms do not limit the nature, sequence or order of the constituent components. It will be further understood that the terms "comprises" and/or "comprising," when used in this specification, specify the presence of stated features, integers, steps, operations, elements, and/or components, but do not preclude the presence or addition of one or more other features, integers, steps, operations, elements, components, and/or groups thereof. As used herein, the term "and/or" includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

Hereinafter, various embodiments disclosed in the present disclosure will be described in detail with reference to the accompanying drawings, and the same or similar elements are designated by the same reference numerals regardless of the numerals in the drawings and redundant description thereof will be omitted.

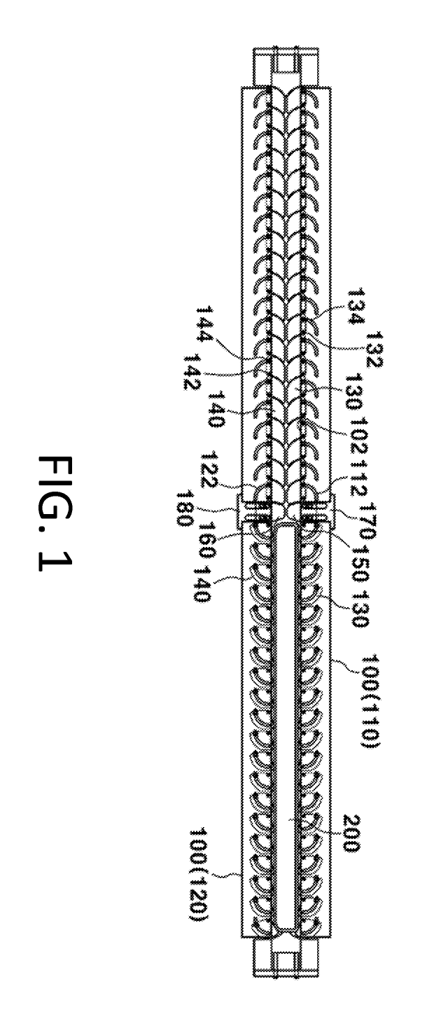

As illustrated in FIG. 1, a shutter door device for a rail is illustratively depicted, in accordance with an exemplary embodiment of the present disclosure.

According to an exemplary embodiment, the shutter door device may comprise a guide rail 100 configured to guide linear movement of a slider 200, a plurality of first rotating blocks 130, and a plurality of second rotating blocks 140 installed on the guide rail 100.

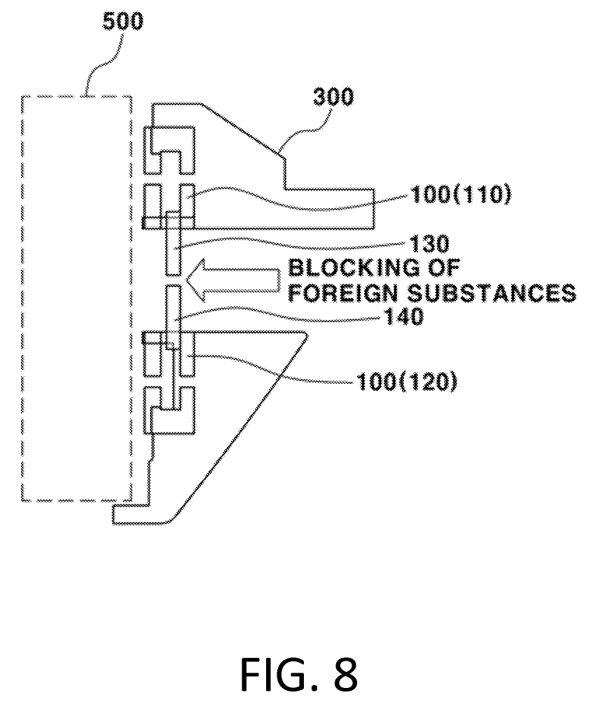

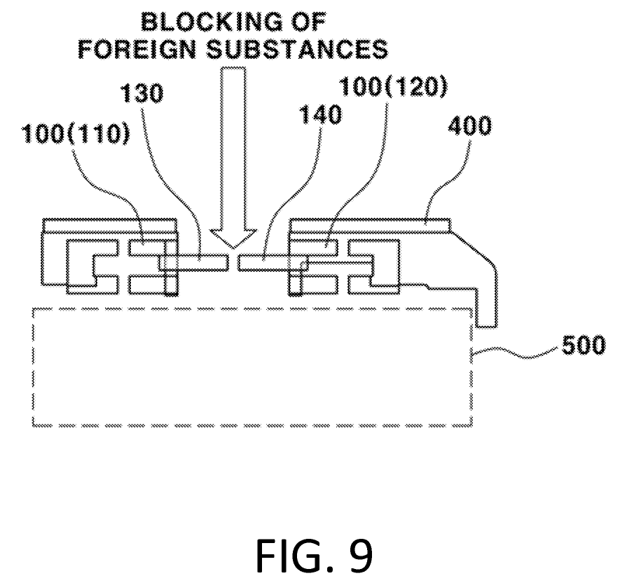

The guide rail 100 may be installed and secured to a rail mounting part. The rail mounting part may be applied in various ways. For example, the rail mounting part may be a crash pad 300 of a vehicle as illustrated in FIG. 8, or a floor panel 400 of a vehicle as illustrated in FIG. 9. In this case, the guide rail 100 may comprise a seat rail or a moving console rail installed on the floor panel 400. In addition, the slider 200 may comprise a position-variable table configured to move forward from the crash pad 300 to be stored or configured to move rearward from the crash pad 300 to be withdrawn. In this case, the guide rail 100 may be integrally provided with the crash pad 300 or may be installed at a predetermined position of the crash pad 300.

The guide rail 100 may be provided with a movement guide passage 102 configured to provide a movement path for the slider 200. The movement guide passage 102 may be configured to extend in a lengthwise direction of the guide rail 100, and may be configured to extend linearly in a length greater than a width of the slider 200 with respect to a movement direction of the slider 200.

With respect to the movement guide passage 102, the guide rail 100 may be divided into a first body portion 110 in a plate shape and a second body portion 120 in a plate shape. That is, the guide rail 100 may comprise the first body portion 110 and the second body portion 120. The first body portion 110 may be positioned opposite the second body portion 120 with respect to the movement guide passage 102.

The slider 200 may be configured to pass through the movement guide passage 102 of the guide rail 100 and to be slidably movable along the movement guide passage 102. The slider 200 may be directly assembled to the guide rail 100 to be slidably movable along the movement guide passage 102 of the guide rail 100, or may be supported to be slidably movable along the movement guide passage 102 of the guide rail 100 through a support structure disposed in a space surrounded by the guide rail 100 and the rail mounting part.

Although not illustrated in detail, referring to FIGS. 8 and 9, a support structure 500 mounted in an inner space of the guide rail 100 and rail mounting parts 300 and 400 is schematically shown. The support structure 500 may be configured to include a structure for supporting the linear movement of the slider 200.

The first rotating blocks 130 may be rotatably assembled to the first body portion 110 of the guide rail 100, and the second rotating blocks 140 may be rotatably assembled to the second body portion 120 of the guide rail 100. The first rotating blocks 130 and the second rotating blocks 140 may be arranged in a row along a lengthwise direction of the movement guide passage 102.

To more effectively close the movement guide passage 102, the first rotating blocks 130 may be disposed adjacent to each other, or may be disposed adjacent to each other in a partially overlapping configuration. Similarly, the second rotating blocks 140 may be disposed adjacent to each other, or may be adjacent to each other in a partially overlapping configuration.

The first rotating blocks 130 and the second rotating blocks 140 may be installed on the guide rail 100 and may be disposed on the movement guide passage 102 so as to close the movement guide passage 102. Based on linear movement of the slider 200 along the movement guide passage 102, the slider 200 may be configured to cause some of the first rotating blocks 130 to rotate toward the first body portion 110 and some of the second rotating blocks 140 to rotate toward the second body portion 120.

Based on the first rotating blocks 130 being pushed by the slider 200, the first rotating blocks 130 may be configured to rotate toward the first body portion 110 so as to open the movement guide passage 102; and based on the first rotating blocks 130 not being pushed by the slider 200, the first rotating blocks 130 may be configured to rotate toward the movement guide passage 102 so as to close the movement guide passage 102.

Similarly, based on the second rotating blocks 140 being pushed by the slider 200, the second rotating blocks 140 may be configured to rotate toward the second body portion 120 so as to open the movement guide passage 102; and based on the second rotating blocks 140 not being pushed by the slider 200, the second rotating blocks 140 may be configured to rotate toward the movement guide passage 102 so as to close the movement guide passage 102. In this case, the first rotating blocks 130 and the second rotating blocks 140 may be configured to rotate in opposite directions to each other.

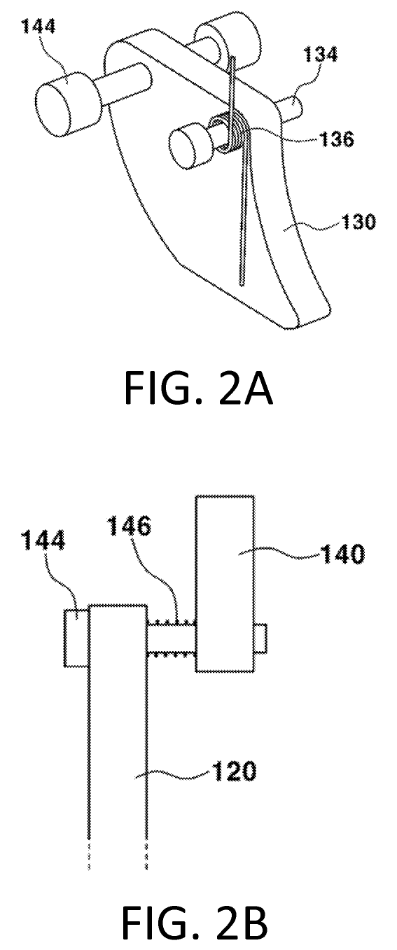

Referring to FIGS. 1 and 2A, each of the first rotating blocks 130 may be provided with a first rotation shaft 132, a first guide pin 134, and a first torsion spring 136. The first rotating block 130 may be formed in a rectangular-plate shape having approximately four corner portions. The first rotating block 130 may be provided with a first corner portion to which the first rotation shaft 132 is assembled, and a second corner portion to which the first guide pin 134 is secured.

The first rotation shaft 132 may be mounted and secured to the first body portion 110, and may be configured to support rotational movement of the first rotating block 130. The first rotating block 130 may be configured to rotate about the first rotation shaft 132. The first rotating block 130 may be rotatably coupled to the first body portion 110 through the first rotation shaft 132.

The first guide pin 134 may be mounted and secured to the second corner portion of the first rotating block 130, and may pass through and be assembled into a first guide hole 112 of the first body portion 110. Based on the rotational movement of the first rotating block 130, the first guide pin 134 may be configured to move along the first guide hole 112.

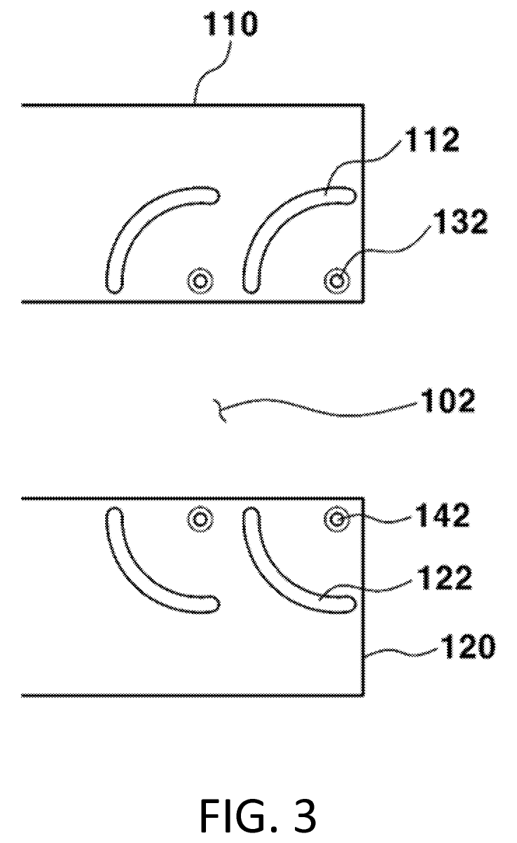

Referring to FIGS. 1 and 3, based on the rotational movement of the first rotating block 130, the first guide hole 112 may be configured to extend to provide and guide a movement path of the first guide pin 134, and may be configured to extend in a curved shape having a predetermined curvature.

The first torsion spring 136 may be assembled on an outer side of the first rotation shaft 132 and disposed between the first body portion 110 and the first rotating block 130, and may comprise a first end coupled to the first body portion 110 and a second end coupled to the first rotating block 130. Based on external load not being applied, the first torsion spring 136 may be configured to maintain the first rotating block 130 in a default state by a spring force of the first torsion spring 136. The default state of the first rotating block 130 is a state in which the movement guide passage 102 is closed.

Based on the first rotating block 130 rotating in a first direction to open the movement guide passage 102, the first torsion spring 136 may be compressed and configured to generate an elastic restoring force. Based on the load causing the first rotating block 130 to rotate in the first direction being removed, the first torsion spring 136 may be configured to rotate the first rotating block 130 in a second direction by the elastic restoring force of the first torsion spring 136. The second direction is a direction opposite to the first direction, and is a direction in which the first rotating block 130 returns to a position where the movement guide passage 102 is closed.

As shown in FIG. 1, the second rotating blocks 140 may be disposed and configured symmetrically with the first rotating blocks 130 with respect to the movement guide passage 102.

Referring to FIGS. 2B and 3, each of the second rotating blocks 140 my be provided with a second rotation shaft 142, a second guide pin 144, and a second torsion spring 146. As with the first rotating block 130, the second rotating block 140 may be formed in a rectangular-plate shape having approximately four corner portions. The second rotating block 140 may be provided with a first corner portion to which the second rotation shaft 142 is assembled, and a second corner portion to which the second guide pin 144 is secured.

The second rotation shaft 142 may be mounted and secured to the second body portion 120, and may be configured to support rotational movement of the second rotating block 140. The second rotating block 140 may be configured to rotate about the second rotation shaft 142. The second rotating block 140 may be rotatably coupled to the second body portion 120 through the second rotation shaft 142.

The second guide pin 144 may be mounted and secured to the second corner portion of the second rotating block 140, and may be configured to pass through and be assembled into a second guide hole 122 of the second body portion 120. Based on the rotational movement of the second rotating block 140, the second guide pin 144 may be configured to move along the second guide hole 122.

Referring to FIGS. 1 and 3, based on the rotational movement of the second rotating block 140, the second guide hole 122 may be configured to extend to provide and guide a movement path of the second guide pin 144, and may be configured to extend in a curved shape having a predetermined curvature.

The second torsion spring 146 may be assembled on an outer side of the second rotation shaft 142 and may be disposed between the second body portion 120, and the second rotating block 140, and may comprise a first end coupled to the second body portion 120 and a second end coupled to the second rotating block 140. Based on external load not being applied, the second torsion spring 146 may be configured to maintain the second rotating block 140 in a default state by a spring force of the second torsion spring 146. The default state of the second rotating block 140 may be a state in which the movement guide passage 102 is closed.

Based on the second rotating block 140 rotating in a third direction to open the movement guide passage 102, the second torsion spring 146 may be compressed and may be configured to generate an elastic restoring force. Based on the load causing the second rotating block 140 to rotate in the third direction being removed, the second torsion spring 146 may be configured to rotate the second rotating block 140 in a fourth direction by the elastic restoring force of the second torsion spring 146. The fourth direction is a direction opposite to the third direction, and is the direction in which the second rotating block 140 returns to a position where the movement guide passage 102 is closed. The third direction is the same direction as the second direction of the first rotating block 130, and the fourth direction is the same direction as the first direction of the first rotating block 130.

In addition, based on the slider 200 being positioned at a first end or a second end of the movement guide passage 102, a first linear block 150 and a second linear block 160 may be installed on the guide rail 100 to prevent the slider 200 from moving freely. In addition, the linear blocks 150 and 160 may also have the effect of covering a gap that may occur in a central portion of the guide rail 100. The rotating blocks 130 and 140 may be provided on both left and right sides of the guide rail 100, and accordingly, a gap may occur in the central portion of the guide rail 100.

The first linear block 150 may be mounted on the first body portion 110 of the guide rail 100 through a first linear guide 170, and the second linear block 160 may be mounted on the second body portion 120 of the guide rail 100 through a second linear guide 180.

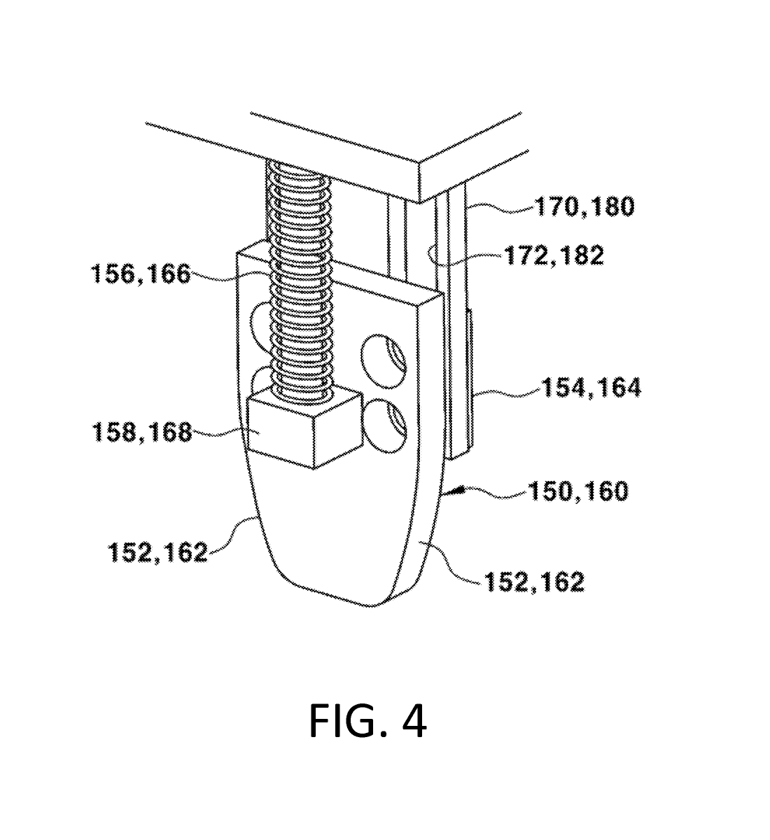

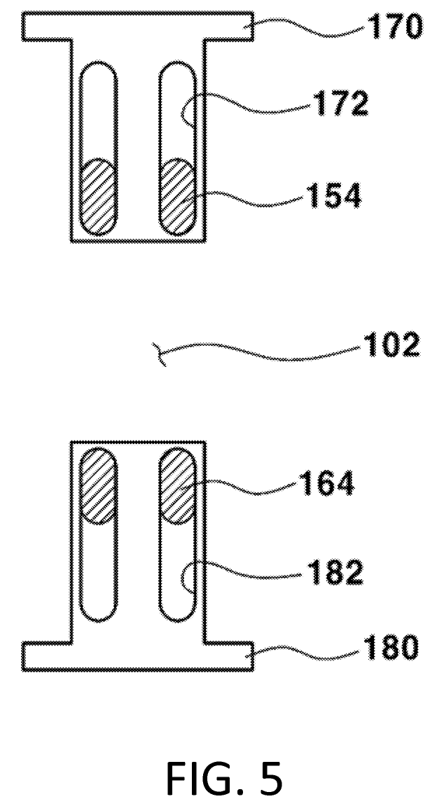

As shown in FIG. 1, the first linear guide 170 may be mounted at a center along an extension direction of the first body portion 110, and may be configured to guide linear movement of the first linear block 150. Referring to FIGS. 4 and 5, the first linear guide 170 may be formed with a first linear hole 172, which provides a linear movement path for the first linear block 150. The first linear guide 170 may be provided with one or more first linear holes 172. The first linear hole 172 may be configured to extend in a direction perpendicular to a movement direction of the slider 200.

The first linear block 150 may be provided with a first guide projection 154, which is assembled to the first linear hole 172 to be linearly movable. The first guide projection 154 may be configured to protrude from a first surface of the first linear block 150. A first support 158, on which a first return spring 156 is mounted, may be configured to protrude from a second surface of the first linear block 150. The first return spring 156 may be installed between the first linear block 150 and the first linear guide 170.

Based on the slider 200 moving along the movement guide passage 102, the first linear block 150 may be configured to be pushed by the slider 200 and may be configured to move along the first linear hole 172. To this end, the first linear block 150 may be provided with a pair of first inclination surfaces 152.

Based on the slider 200 moving along the movement guide passage 102, the pair of first inclination surfaces 152 may be configured to selectively come into contact with the slider 200 and may be configured to be pushed by the slider 200. Based on any one of the first inclination surfaces 152 being pushed by the slider 200, the first linear block 150 may be configured to move along the first linear hole 172 and open the movement guide passage 102.

The first inclination surface 152 may be formed to have a predetermined curvature, and may be formed as a gently curved surface. In this case, both ends of the slider 200, which come into contact with the first inclination surface 152, may also have gently curved surfaces. A curvature of the first inclination surface 152 may be determined to have a curvature value that is favorable for being pushed and moved by the slider 200.

Based on the first linear block 150 moving in a direction to open the movement guide passage 102, the first return spring 156 may be compressed and may be configured to generate an elastic restoring force. Based on the load applied by the slider 200 being removed, the first linear block 150 may be configured to move in a direction to close the movement guide passage 102 by the elastic restoring force of the first return spring 156 and may be configured to return to an original position of the first linear block 150.

The plurality of first rotating blocks 130 assembled on the first body portion 110 of the guide rail 100 may be disposed and mounted symmetrically with each other with respect to the first linear guide 170 and the first linear block 150.

In addition, as shown in FIG. 1, the second linear guide 180 may be mounted at a center along an extension direction of the second body portion 120, and may be configured to guide linear movement of the second linear block 160. The second linear guide 180 may be disposed to face the first linear guide 170 with respect to the movement guide passage 102. The second linear guide 180 may be symmetrical with the first linear guide 170 with respect to the movement guide passage 102.

Referring to FIG. 5, the second linear guide 180 may be formed with a second linear hole 182, which provides a linear movement path for the second linear block 160. The second linear guide 180 may be provided with one or more second linear holes 182. The second linear hole 182 may extend in a direction perpendicular to a movement direction of the slider 200.

The second linear block 160 may be provided with a second guide projection 164, which is assembled to the second linear hole 182 to be linearly movable. The second guide projection 164 may be configured to protrude from a first surface of the second linear block 160.

Referring to FIG. 4, a second support 168, on which a second return spring 166 is mounted, may be configured to protrude from a second surface of the second linear block 160. The second return spring 166 may be installed between the second linear block 160 and the second linear guide 180.

Based on the slider 200 moving along the movement guide passage 102, the second linear block 160 may be configured to be pushed by the slider 200 and move along the second linear hole 182. To this end, the second linear block 160 may be provided with a pair of second inclination surfaces 162.

Based on the slider 200 moving along the movement guide passage 102, the pair of second inclination surfaces 162 may be configured to selectively come into contact with the slider 200 and my be configured to be pushed by the slider 200. Based on the second inclination surface 162 being pushed by the slider 200, the second linear block 160 may be configured to move along the second linear hole 182 and open the movement guide passage 102.

The second inclination surface 162 may be formed to have a predetermined curvature, and may be formed as a gently curved surface. In this case, both ends of the slider 200, which come into contact with the second inclination surface 162, may also have gently curved surfaces.

Based on the second linear block 160 moving in a direction to open the movement guide passage 102, the second return spring 166 may be compressed and may be configured to generate an elastic restoring force. Based on the load applied by the slider 200 being removed, the second linear block 160 may be configured to move in a direction to close the movement guide passage 102 by the elastic restoring force of the second return spring 166 and return to an original position of the second linear block 160.

The plurality of second rotating blocks 140 assembled on the second body portion 120 of the guide rail 100 may be disposed and mounted symmetrically with each other with respect to the second linear guide 180 and the second linear block 160.

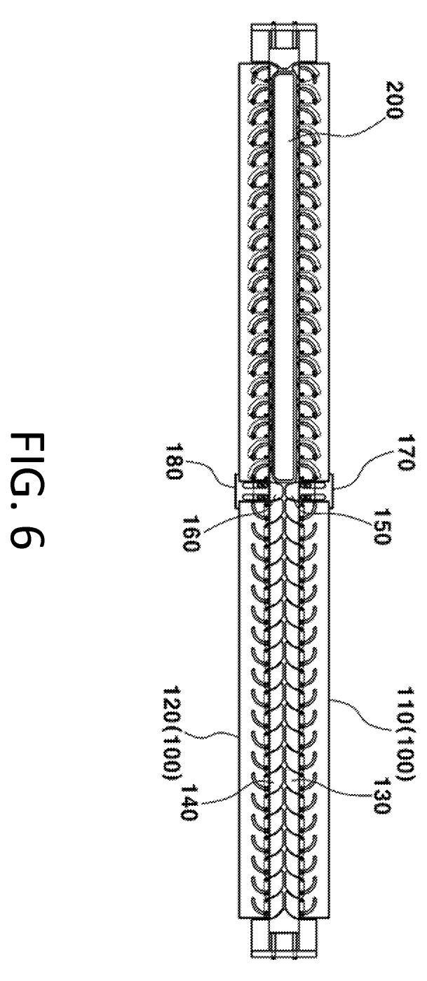

FIG. 6 illustrates a state in which the slider 200 has moved to a first end of the guide rail 100. The movement of the slider 200 to the first end of the guide rail 100 may be configured to cause the first rotating blocks 130 and the second rotating blocks 140 installed at a second end of the guide rail 100 to close the movement guide passage 102.

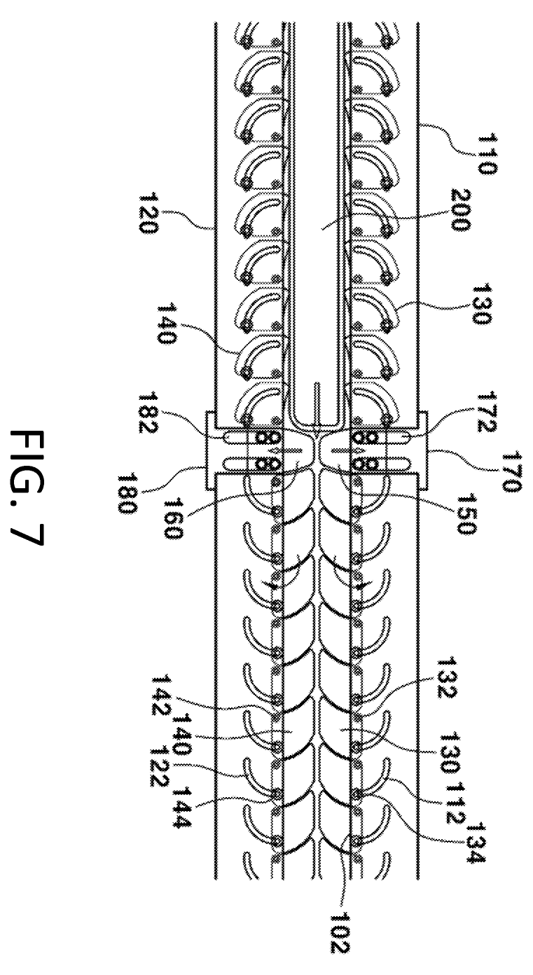

FIG. 7 indicates, with arrows, directions in which the first rotating blocks 130 and the second rotating blocks 140 rotate to open the movement guide passage 102 based on the slider 200 moving back to the second end of the guide rail 100.

Referring to FIGS. 1 and 7, based on the slider 200 moving along the movement guide passage 102, the first rotating blocks 130 and the second rotating blocks 140, which come into contact with the slider 200, may be configured to be pushed by the slider 200 and rotate so as to open the movement guide passage 102; and the first rotating blocks 130 and the second rotating blocks 140, which are released from contact with the slider 200, may be configured to automatically return to positions where the movement guide passage 102 is closed by the elastic restoring force of the first torsion spring 136 and the second torsion spring 146, respectively.

Embodiments of the present disclosure have been described in detail above; however, the terms used herein and in the claims should not be construed as being limited to their ordinary or dictionary meanings. In addition, the scope of rights of the present disclosure is not limited to the embodiments described above, but also includes various modifications and changes by those skilled in the art utilizing the basic concept of the present disclosure as defined by the following claims.

What is claimed is:

1. A shutter door device for a rail, the shutter door device comprising:
a guide rail configured to guide linear movement of a slider;
a movement guide passage provided in the guide rail,
wherein the movement guide is configured to provide a movement path for the slider; and
a plurality of rotating blocks rotatably assembled to a body portion of the guide rail and arranged in a row in the movement guide passage,
wherein the plurality of rotating blocks are configured to rotate in a direction to open the movement guide passage when the slider moves along the movement guide passage.

2. The shutter door device of claim 1, wherein:
each of the plurality of rotating blocks is rotatably coupled to the body portion through a rotation shaft and is provided with a guide pin assembled into a guide hole of the body portion, and
based on each of the plurality of rotating blocks rotating about the rotation shaft, the guide pin is configured to move along the guide hole.

3. The shutter door device of claim 2, wherein the guide hole extends to guide a rotational movement path of each of the plurality of rotating blocks.

4. The shutter door device of claim 1, further comprising a torsion spring installed between the body portion and each of the plurality of rotating blocks,
wherein:
the torsion spring comprises a first end coupled to the body portion and a second end coupled to each of the plurality of rotating blocks, and
based on each of the plurality of rotating blocks rotating in a direction to open the movement guide passage, the torsion spring is configured to be compressed.

5. The shutter door device of claim 1, further comprising:
a linear guide provided at a center of the body portion; and
a linear block assembled to the linear guide and disposed in the movement guide passage,
wherein:
the linear guide is provided with a linear hole for guiding movement of the linear block, and
the linear hole extends in a direction perpendicular to a movement direction of the slider.

6. A shutter door device for a rail, the shutter door device comprising:
a guide rail configured to guide linear movement of a slider;
a movement guide passage provided in the guide rail,
wherein the movement guide is configured to provide a movement path for the slider;
a plurality of first rotating blocks rotatably assembled to a first body portion of the guide rail and arranged in a row in the movement guide passage; and
a plurality of second rotating blocks rotatably assembled to a second body portion of the guide rail and arranged in a row in the movement guide passage,
wherein:
the first body portion is positioned opposite the second body portion with respect to the movement guide passage, and
the first rotating blocks and the second rotating blocks are configured to rotate in a direction to open the movement guide passage when the slider moves along the movement guide passage.

7. The shutter door device of claim 6, wherein:
each of the first rotating blocks is rotatably coupled to the first body portion through a first rotation shaft and is provided with a first guide pin assembled into a first guide hole of the first body portion, and
based on each of the first rotating blocks rotating about the first rotation shaft, the first guide pin is configured to move along the first guide hole.

8. The shutter door device of claim 7, wherein the first guide hole extends to guide a rotational movement path of each of the first rotating blocks.

9. The shutter door device of claim 6, further comprising a first torsion spring installed between the first body portion and each of the first rotating blocks,
wherein:
the first torsion spring comprises a first end coupled to the first body portion and a second end coupled to each of the first rotating blocks, and
based on each of the first rotating blocks rotating in a direction to open the movement guide passage, the first torsion spring is configured to be compressed.

10. The shutter door device of claim 6, wherein:
each of the second rotating blocks is rotatably coupled to the second body portion through a second rotation shaft and is provided with a second guide pin assembled into a second guide hole of the second body portion, and
the second guide pin is configured to move along the second guide hole, based on each of the second rotating blocks rotating about the second rotation shaft.

11. The shutter door device of claim 10, wherein the second guide hole extends to guide a rotational movement path of each of the second rotating blocks.

12. The shutter door device of claim 6, further comprising a second torsion spring installed between the second body portion and each of the second rotating blocks,
wherein:
the second torsion spring comprises a first end coupled to the second body portion and a second end coupled to each of the second rotating blocks, and
based on each of the second rotating blocks rotating in a direction to open the movement guide passage, the second torsion spring is configured to be compressed.

13. The shutter door device of claim 6, further comprising:
a first linear guide provided at a center of the first body portion; and
a first linear block assembled to the first linear guide and disposed in the movement guide passage,
wherein:
the first linear guide is provided with a first linear hole for guiding movement of the first linear block, and
the first linear hole extends in a direction perpendicular to a movement direction of the slider.

14. The shutter door device of claim 13, further comprising first inclination surfaces having a predetermined curvature provided on both sides of the first linear block, respectively,
wherein, based on the slider moving along the movement guide passage, the first inclination surfaces are configured to be pushed by coming into contact with the slider.

15. The shutter door device of claim 13, further comprising a first return spring mounted between the first linear block and the first linear guide,
wherein, based on the first linear block moving by being pushed by the slider, the first return spring is configured to be compressed.

16. The shutter door device of claim 13, wherein the plurality of first rotating blocks assembled to the first body portion are symmetrical with each other with respect to the first linear block.

17. The shutter door device of claim 6, further comprising:
a second linear guide provided at a center of the second body portion; and
a second linear block assembled to the second linear guide and disposed in the movement guide passage,
wherein:
the second linear guide is provided with a second linear hole for guiding movement of the second linear block, and
the second linear hole extends in a direction perpendicular to a movement direction of the slider.

18. The shutter door device of claim 17, further comprising second inclination surfaces having a predetermined curvature provided on both sides of the second linear block, respectively,
wherein, based on the slider moving along the movement guide passage, the second inclination surfaces are configured to be pushed by coming into contact with the slider.

19. The shutter door device of claim 17, further comprising a second return spring mounted between the second linear block and the second linear guide,
wherein, based on the second linear block moving by being pushed by the slider, the second return spring is configured to be compressed.

20. The shutter door device of claim 17, wherein the plurality of second rotating blocks assembled to the second body portion are symmetrical with each other with respect to the second linear block.
